(19) United States
(12) Patent Application Publication
(10) Pub. No.: US 2004/0238990 A1
(43) Pub. Date: Dec. 2, 2004

(54) Method for producing a component and associated device

(76) Inventors: Andreas Hermann, Gaertringen (DE); Karl-Heinz Ilzhoefer, Kirchheim (DE); Thomas Schuh, Waiblingen (DE); Thorsten Wesse, Gaeufelden (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/481,274

(22) PCT Filed: Apr. 9, 2002
(86) PCT No.: PCT/EP02/03909

(30) Foreign Application Priority Data
Jun. 19, 2001 (DE) 101 29 224.4

(51) Int. Cl. B29C 47/76

(52) U.S. Cl. 264/102; 425/203; 264/211.23

(57) ABSTRACT

A process for producing a component from a sheet molding compound (SMC) material includes raw-material preparation, semi-finished product production and component shaping.

The raw-material preparation is carried out by at least one extruder.

A semi-finished product is produced in a mold by an extruder, and

the raw-material preparation and the semi-finished product production take place in an integrated process step.

### BACKGROUND OF THE INVENTION

The present invention relates to a process for producing a component from a sheet molding compound material and to a device for carrying out the process.

The production of components from sheet molding compounds (SMC) is a process which is highly complex and is also difficult to control in terms of quality assurance. In the text which follows, the term “SMC” materials is to be understood as meaning thermosetting, fiber-reinforced composite plastics. For this purpose, raw materials, including resins, hardeners, diluents and fillers, such as calcium carbonate or aluminum hydroxide, are mixed in a vessel to form a raw material mixture.

This mixing operation already causes air to be introduced in the form of fine bubbles which subsequently have an adverse effect on the component quality, for example on account of the formation of pores. Moreover, the mixing, which is carried out by a stirrer, does not precisely regulate the introduction of energy, and this in turn has an effect on the viscosity of the raw-material mixture.

This mixture is then introduced from a storage container into what is known as an SMC installation. The SMC installation is used to produce SMC semi-finished products. To this end, the mixture is provided with a thickener (generally magnesium oxide) and is cast onto a horizontally moving endless film and then smoothed using a doctor to a desired thickness of usually between 1 mm and 3 mm. The film serves as a support film for the raw-material mixture.

As the process continues, fibers, in particular glass fibers, are cut or broken onto the raw-material mixture. This is followed by cut glass fibers being distributed uniformly over the surface of the raw material. A further film with raw-material mixture which is moving concomitantly is then joined to the fibers in such a way that an endless strip is formed, protected at the top and bottom sides by a film and containing the raw-material mixture including fibers in the interior. This strip then passes through various roll stands, where it is compressed and the fibers are impregnated with the mixture. At the same time, the strip is roughly deaerated by this operation.

The strip is rolled up as a semi-finished product mat and subjected to a maturing process lasting 2-7 days. Then, the semi-finished product is cut to a desired target weight and then pressed in a press with a shaping mold to form a component. During the pressing operation, the semi-finished product is heated, causing the component to cure.

Drawbacks of this process are in particular the complex, long-winded procedure and the inadequate quality assurance. The weight per unit area and other parameters of the semi-finished product cannot be maintained with sufficient accuracy, on account of fluctuations in the viscosity, and moreover various process steps (mixing of the raw materials, joining of the films) introduce inclusions of air which allow the density of the material and/or the weight per unit area of the semi-finished product to fluctuate. The result of these fluctuations is that very complex compression molds have to be constructed and produced, making the process even more expensive.

Hitherto, these design drawbacks have meant that these SMC materials have been considered unsuitable for use in a large-series process for high-quality components.

### SUMMARY OF THE INVENTION

Therefore, it is an object of the present invention to provide a process for producing SMC components which entails lower process costs compared to the prior art and allows improved quality assurance.

The object has been achieved by a process in which raw materials, comprising resin, hardener, fillers and fibers are prepared in a raw-material preparation step by at least one extruder, a semi-finished produce is produced from the prepared raw materials in a mold by an extruder, wherein the raw-material preparation and the semi-finished product production takes place continuously in an integrated process step.

The inventive process comprises the steps of raw-material preparation, semi-finished product production and component shaping. According to the present invention, the raw-material preparation takes place in one or more extruders. For this purpose, the raw materials are added to the extruder and mixed homogenously. The raw materials in this case include, inter alia, resin, hardener, diluent, such as styrene, fillers (e.g., calcium carbonate, aluminum hydroxide or silica), other additives and fibers. The viscosity can be set deliberately and the amount of air included is kept very low.

Then, a semi-finished product is pressed direct from the extruder by way of a suitably shaped mold. The mold usually takes the shape of a rectangular plate, but it is also possible to produce other geometries which optimally correspond to the final component. In this way, it is possible to dispense with the need to trim the semi-finished products, with the result that raw-material costs are saved.

The raw-material preparation and the semi-finished product production therefore take place in an integrated, continuous process step. This avoids a plurality of process steps, for example the maturing of the semi-finished product, and greatly reduces production costs and facilitates quality control. Compared to the prior art, the semi-finished products which are produced in accordance with the present invention have considerably more constant material densities, weights per unit area and geometric dimensions, which in turn facilitates component shaping and can lead to the use of less expensive molds.

The raw-material preparation can be made particularly advantageous if a cascade of extruders is used. The individual components of the raw material can be added in targeted fashion. The extruders have conveyor screws (for example planetary screws, twin screws, single screws), which mix the material, homogenize it and convey it without any additional air being introduced. The screws of the individual extruders in the cascade preferably have different geometries or structural forms. This makes it possible for the individually introduced raw materials to be optimally introduced into the raw-material mixture in the extruder and homogenized. Further parameters which influence the homogenization of the raw-material mixture include the rotational speed and the running direction of the extruder screw.

Deaerating of one or more extruders further optimizes the semi-finished product quality, in particular leads to a more constant weight per unit area of the semi-finished product.

A further advantageous configuration of the invention consists in feeding endless fibers to the at least one extruder. These fibers are cut or, in particular in the case of glass fibers, broken to a desired length directly as they are being introduced or just before they are introduced. The fibers are preferably introduced at the end of the extrusion process, because this avoids damaging shear loads on the fibers.

However, it may also be expedient for the endless fibers to be introduced into the extruder and be comminuted by the extruder screw. In addition or as an alternative to short fibers, the process according to the present invention also provides the option of endless fibers being introduced directly into the mold at the end of the extrusion process, without these endless fibers being comminuted. These fibers act as unidirectional long-fiber reinforcement, thereby increasing the strength of the component.

The fibers are usually glass fibers, which have a sufficiently high tensile strength and are also relatively inexpensive. However, other types of fiber, such as carbon fibers or organic fibers, such as aramid fibers, are also contemplated as expedient.

A further part of the invention is a device for carrying out the process. An extruder or a cascade of a plurality of extruders can be filled with raw materials comprising various individual components. Extruder screws homogenize the raw material and convey it under pressure through an outlet opening into a mold. The mold is used to shape a semi-finished product.

To optimize the homogeneity of the raw material, the extruder(s) is (are) provided with a deaerating mechanism through which air that may be present in the raw materials can escape.

At least one extruder may include a fiber-feed device. This device conveys endless fibers directly into the extruder, or into the extruder screw, cuts or breaks the fibers to the desired length and admixes them with the raw material.

### BRIEF DESCRIPTION OF THE DRAWINGS

These and other objects, features and advantages of the present invention will become more readily apparent from the following detailed description of currently preferred configurations thereof when taken in conjunction with the accompanying drawings wherein:

FIG. 1 is a schematic diagram showing a device for carrying out a process according to the present invention.

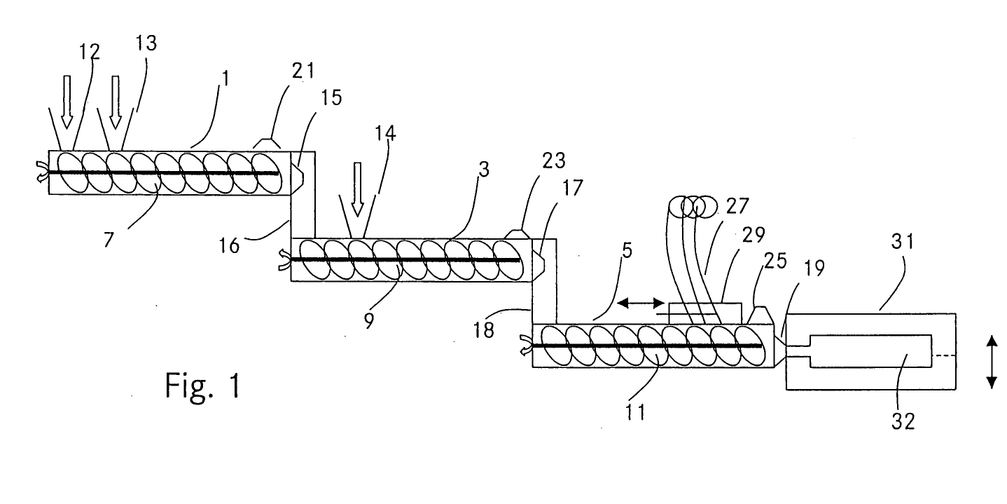

A cascade of three extruders 1, 3, 5, as shown in FIG. 1, with extruder screws 7, 9, 11 having respective filling devices 12, 13, 14. At one end, the extruders are each provided with an outlet opening 15, 17, 19. The extruders 1 and 3 are connected via feed shafts 16 and 18. In addition, the extruders each have a known type of deaerating device 21, 23, 25. The extruder 5 is provided with a fiber-cutting device 29 which is used to comminute endless fibers 27 and to feed cut fibers into the extruder 5. The outlet opening 19 of the extruder 5 opens out into a mold 31, which has a mold cavity 32 and is suitable for producing SMC semi-finished products.

The extruder 1 is filled with the liquid components of the raw material (resin, hardener, styrene, any additives) via the filling devices 12 and 13. These components are homogenized in the extruder screw 7. Any inclusions of air which may be introduced during the filling operation are vented through a deaerating valve 21 during the homogenization operation in the extruder 1. The homogenized liquid raw material is fed to the extruder 3 via the outlet opening 15 and the feed shaft 16.

Then, further raw materials, in the form of solid components, which serve as fillers, are admixed by the filling device 14. Suitable solid components are in particular calcium carbonate, aluminum hydroxide or silica. The process according to the present invention does not require a thickener, such as for example magnesium oxide, as is used in the conventional process. The raw-material mixture is in turn homogenized with the newly added components, further deaerating takes place via the deaerating device 23, and the homogenized mixture is passed on into the extruder 5 via the outlet opening 17 and the feed shaft 18.

The extruder screw 11 of the extruder 5 conveys the mixture onward and homogenizes it further. At the end of the extruder 5, glass fibers 27 are introduced into the raw-material mixture. The glass fibers 27, which are configured as endless fibers, are fed to a comminution device 29, in which they are broken into short fibers with a length of between 2 mm and 50 mm. The fibers are introduced at the end of the homogenization process, in order to minimize excessive shearing and therefore damage to the fibers. This is followed by a final deaerating step through the deaerating device 25. The homogenized raw material is then conveyed through the outlet opening 19 into the mold cavity 32 of the mold 31.

The mold cavity 32 is filled with the raw material under pressure by the extruder screw 11. The geometry of the semi-finished product produced in this way is extremely constant because it is determined by the tolerances of the mold. This leads to an above-average constancy of the weight per unit area of the semi-finished product. Inclusions of air are reduced to a minimum by the preparation process of the raw materials according to the invention and the repeated deaerating. This is advantageous for volumetrically accurate, reliable metering to compression molds for component production.

The semi-finished product which has been produced in accordance with the invention is then placed into a compression mold (not shown). The process according to the invention does not require a maturing time for the semi-finished product, as is required with the conventional process, which considerably reduces the production costs.

On account of the precise geometry of the semi-finished product and the fact that the weight per unit area of the semi-finished product is only subject to very slight tolerances, the compression mold may be configured as a pinch-edge mold. The advantage of a pinch-edge mold over a positive mold which is customarily used is the greatly reduced tooling costs. Positive molds require significantly greater tolerances than pinch-edge molds and are therefore significantly more expensive. Moreover, positive molds are subject to high levels of wear.

In the compression mold, the final component geometry is imparted to the semi-finished product. The mold is heated, with the result that the semi-finished product is also heated. The hardener contained in the raw material cures the resin, which leads to a crosslinked thermosetting plastic matrix which is reinforced by glass fibers and fillers and is referred to as an SMC material. Finally, the component made from SMC material is demolded and if appropriate subjected to any final machining which may be required.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

1.-11. (Cancelled).

12. A process for producing a component from a thermosetting, fiber-reinforced sheet molding compound (SMC) material, comprising preparing raw materials including resin, hardener, fillers and fibers by at least one extruder, and producing a semi-finished product from the prepared raw materials in a mold by an extruder, wherein the raw-material preparation and the semi-finished product production takes place continuously in an integrated process step.

13. The process as claimed in claim 12, wherein the raw-material preparation takes place in a cascade of extruders.

14. The process as claimed in claim 13, wherein the raw material preparation includes subjecting the raw materials to screws of the extruder cascade having different geometries, rotational speeds and running directions.

15. The process as claimed in claim 12, further comprising deaerating the raw material during the raw material preparation in the at least one extruder.

16. The process as claimed in claim 15, wherein the raw-material preparation takes place in a cascade of extruders.

17. The process as claimed in claim 16, wherein the raw material preparation includes subjecting the raw materials to screws of the extruder cascade having different geometries, rotational speeds and running directions.

18. The process as claimed in claim 12, further comprising feeding endless fibers to the at least one extruder, and cutting or breaking the endless fibers immediately before being fed or as they are fed into the at least one extruder.

19. The process as claimed in claim 18, wherein the raw-material preparation takes place in a cascade of extruders.

20. The process as claimed in claim 19, wherein the raw material preparation includes subjecting the raw materials to screws of the extruder cascade having different geometries, rotational speeds and running directions.

21. The process as claimed in claim 20, further comprising deaerating the raw material during the raw material preparation in the at least one extruder.

22. The process as claimed in claim 18, further comprising feeding endless fibers to the at least one extruder, which endless fibers are comminuted by a screw of the at least one extruder.

23. The process as claimed in claim 12, further comprising introducing endless fibers unidirectionally into the mold through an inlet opening.

24. The process as claimed in claim 18, wherein the endless fibers are selected from the group consisting of glass fibers, carbon fibers, aramid fibers and metal fibers.

25. The process as claimed in claim 22, wherein the endless fibers are selected from the group consisting of glass fibers, carbon fibers, aramid fibers and metal fibers.

26. The process as claimed in claim 23, wherein the endless fibers are selected from the group consisting of glass fibers, carbon fibers, aramid fibers and metal fibers.

27. A device for carrying out the process as claimed in claim 12, comprising at least one extruder having at least one extruder screw for preparing a raw material and producing a semi-finished product, and at least one mold for component shaping associated with the at least one extruder so as to provide the continuous integrated process.

28. The device as claimed in claim 27, wherein the at least one extruder includes at least one deaerating device.

29. The device as claimed in claim 27, wherein the at least one extruder has a fiber-feed device and optionally a fiber-comminution device.

30. The device as claimed in claim 29, wherein the at least one extruder includes at least one deaerating device.
